(19) United States
(12) Patent Application Publication
(10) Pub. No.: US 2012/0175937 A1
(43) Pub. Date: Jul. 12, 2012

(54) SEAT BELT RETRACTOR AND PRETENSIONER

(75) Inventors: Peter P. Kujawa, Howell, MI (US); Gregory S. Ches, Clinton Township, MI (US); Thomas Tilly, Algonac, MI (US); Leslie A. Sajovec, Beverly Hills, MI (US); Steven G. Corrion, Oxford, MI (US)

(73) Assignee: GM GLOBAL TECHNOLOGY OPERATIONS LLC, Detroit, MI (US)

(21) Appl. No.: 12/987,509

(22) Filed: Jan. 10, 2011

(51) Int. Cl. B60R 22/195

(52) U.S. Cl. 297/480

(57) ABSTRACT

A seat belt system for a vehicle includes a seat frame. The seat belt system also includes a lap belt having a first end and a second end, wherein the first end is connected to a buckle and the second end is connected to an anchor. The seat belt system additionally includes a single retractor-pretensioner operatively connected to the seat frame and configured to simultaneously tension the first end and the second end. A vehicle having a seat with a frame that is operatively connected to the vehicle structure and employing the seat belt system is also provided.

### TECHNICAL FIELD

The invention relates to a retractor and a pretensioner for a seat belt.

### BACKGROUND

Seat belts are designed to secure an occupant of a vehicle against unintended movement that may result if the vehicle is involved in a collision or in a sudden stop. A properly worn seat belt is also designed to ensure that the wearer of the belt is in a proper position for protection by a deployable airbag. Seat belts are additionally designed to absorb energy by stretching during sudden deceleration to reduce a speed differential between the passenger's body and the vehicle interior. Vehicle seat belt systems are frequently equipped with pretensioners to preemptively tighten the belt around the wearer during sudden deceleration.

### SUMMARY

A seat belt system for a vehicle includes a seat frame. The seat belt system also includes a lap belt having a first end and a second end, wherein the first end is connected to a buckle and the second end is connected to an anchor. The seat belt system additionally includes a single retractor-pretensioner operatively connected to the seat frame and configured to simultaneously tension the first end and the second end.

The single retractor-pretensioner may include a spool operatively connected to the first end of the belt via a first cable and to the second end of the belt via a second cable.

The spool may include a first channel and a second channel. In such a case, the first channel may be configured to accept and guide the first cable and the second channel may be configured to accept and guide the second cable.

The seat frame may include a first structure configured to support a seatback and a second structure configured to support a cushion. In such a case, the single retractor-pretensioner may be operatively connected to the second structure and positioned under the cushion. The single retractor-pretensioner may also be operatively connected to the first structure and positioned against the seatback.

The single retractor-pretensioner may be configured to rotate the spool and simultaneously tension the first and second ends of the belt.

The seat belt system may additionally include a sensor positioned on the vehicle and configured to generate a signal in response to a force having a predetermined magnitude. In such a case, the single retractor-pretensioner may be triggered by the signal.

The single retractor-pretensioner may include a pretensioning tube that is operatively connected to the spool. In such a case, the pretensioning tube may house a pyrotechnic that is triggered to simultaneously tension the first and second ends of the belt in response to the signal.

Additionally, the seat belt system may include a controller that is configured to trigger the pyrotechnic in response to the signal.

A vehicle having the disclosed seat belt system is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a seat belt system including a seat mounted in a vehicle and having a single retractor-pretensioner for a lap belt, wherein the single retractor-pretensioner is located relative to the seat cushion;

FIG. 2 is a close-up perspective view of the single retractor-pretensioner shown in FIG. 1; and

FIG. 3 is a perspective view of the seat belt system shown in FIG. 1, wherein the single retractor-pretensioner is positioned against the seatback.

### DETAILED DESCRIPTION

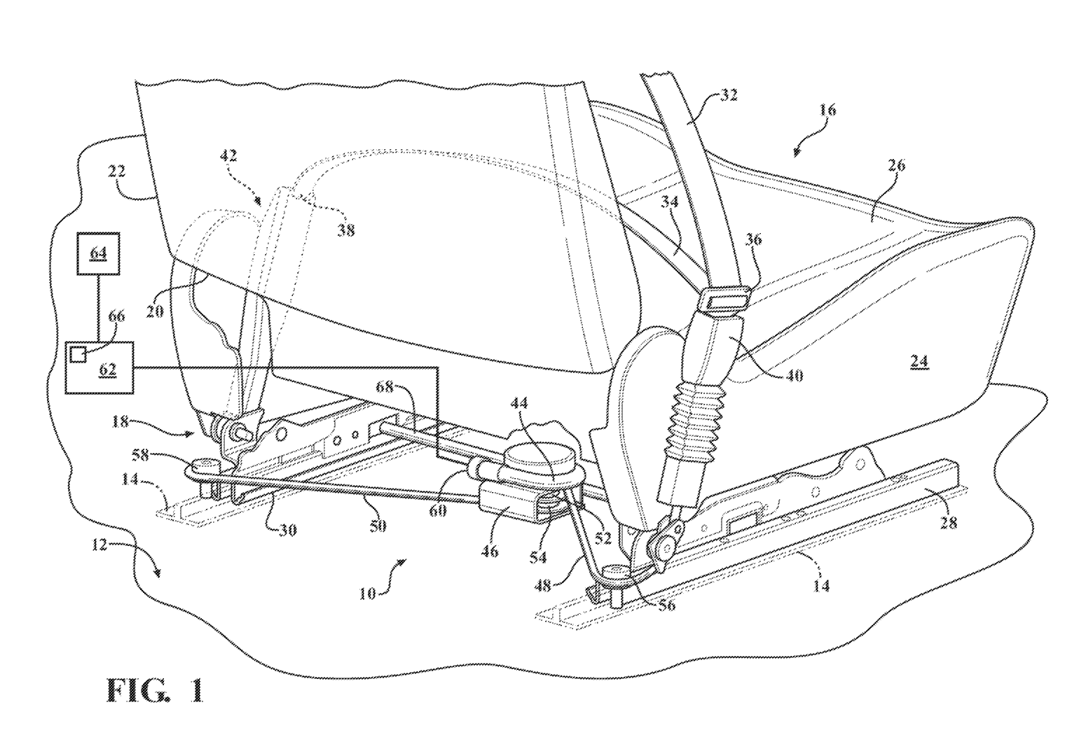

Referring to the drawings, wherein like reference numbers refer to like components, FIG. 1 shows a perspective view of a seat belt system 10 positioned inside a vehicle 12 and operatively connected to a vehicle structure 14. The seat belt system 10 includes a seat 16 positioned inside the vehicle 12 and operatively connected to the vehicle structure 14. The seat 16 includes a seat frame 18. The seat frame 18 includes a first seat structure 20 that is configured to support a seatback 22. The seat frame 18 also includes a second seat structure 24 that is configured to support a cushion 26. The first seat structure 20 is pivotably attached to the second seat structure 24 to accommodate an occupant of the vehicle 12. The second seat structure 24 includes a first track 28 and a second track 30. The seat 16 is slidably attached to the vehicle structure 14 via the first track 28 and the second track 30.

The seat belt system 10 is configured to provide a safety restraint for an occupant of the seat 16. The seat belt system 10 includes a shoulder belt 32 and a lap belt 34, wherein the shoulder belt 32 is configured to be worn around the torso of the occupant of the seat 16, and the lap belt 34 is configured to be worn around the occupant's waist. The lap belt 34 includes a first end 36 and a second end 38. The first end 36 is connected to a buckle 40 and the second end 38 is connected to an anchor 42. The seat belt system 10 also includes a single retractor-pretensioner 44. The single retractor-pretensioner 44 is operatively connected to the seat frame 18 and is configured to simultaneously tension the first end 36 and the second end 38.

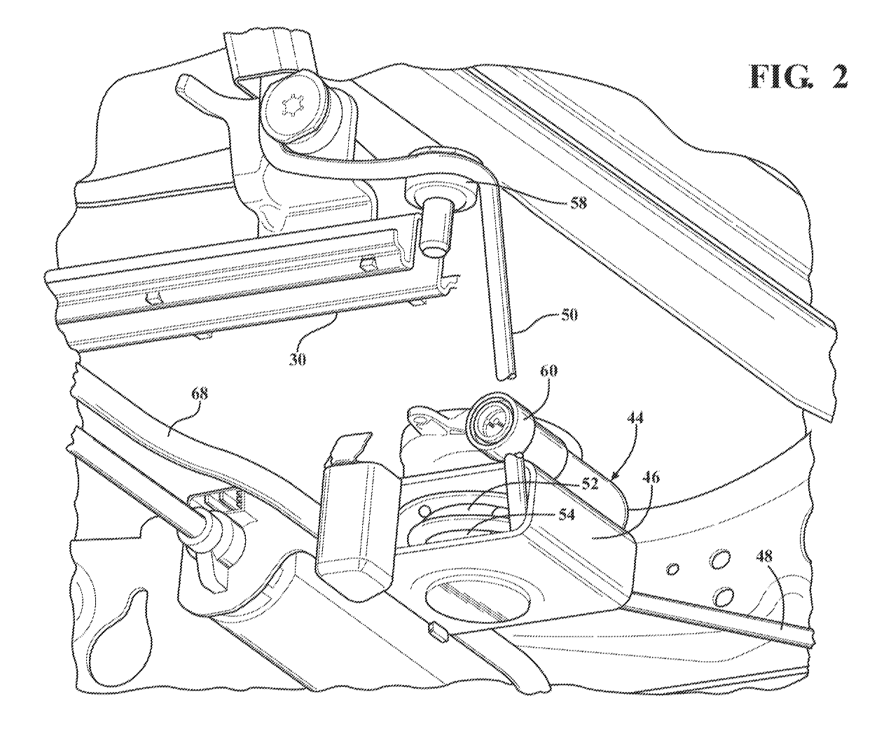

FIG. 2 is a close-up illustration of the single retractor-pretensioner 44. As shown in each of FIGS. 1 and 2, the retractor-pretensioner 44 includes a spool 46. The spool 46 is operatively connected to the first end 36 via a first cable 48 and to the second end 38 via a second cable 50. The spool 46 includes a first channel 52 and a second channel 54. The first channel 52 is configured to accept and guide the first cable 48, while the second channel 54 is configured to accept and guide the second cable 50. The first cable 48 is routed to a first bearing surface 56, while the second cable 50 is routed to a second bearing surface 58. The first bearing surface 56 changes the direction of the first cable 48 and directs the first cable to the buckle 40, while the second bearing surface 58 changes the direction of the second cable 50 and directs the second cable to the lap anchor 42. As shown in each of the FIGS. 1 and 2, the first and second bearing surfaces 56 and 58 are operatively attached to the respective first and second tracks 28 and 30. Each of the first and second bearing surfaces 56 and 58 may be configured as a pulley.

The single retractor-pretensioner 44 includes a pretensioning tube 60 that houses a pyrotechnic, i.e., an explosive, that is configured to be triggered in order to rotate the spool 46. Accordingly, the single retractor-pretensioner 44 is configured to rotate the spool 46 to pull on the first and second cables 48, 50 and simultaneously tension the first and second ends 36, 38 of the lap belt 34 upon activation by the pyrotechnic. The tensioning of the first and second ends 36, 38 is performed in response to a force having a predetermined magnitude acting on the vehicle 12 and the seat 16. The contemplated force may be the type that occurs during sudden deceleration of the vehicle 12 and/or during a roll-over of the vehicle. The predetermined magnitude of the force may be established based on theoretical analysis and/or empirically during brake and impact testing of the vehicle 12. The single retractor-pretensioner 44 is configured to preemptively tighten the lap belt 34 and secure the occupant of the vehicle 12 with respect to the seat 16.

The vehicle 12 includes a controller 62. The vehicle 12 also includes a sensor 64 operatively connected to the vehicle structure 14. The sensor 64 is configured to generate a signal 66 and communicate the signal to the controller 62 in response to the force reaching the predetermined magnitude. The controller 62 is programmed to trigger the single retractor-pretensioner 44 upon receiving from the sensor 64 the signal 66 that is indicative of the predetermined magnitude of the force. As described above, the single retractor-pretensioner 44 includes the pretensioning tube 60 that houses a pyrotechnic. The pyrotechnic is used to simultaneously tension the first and second ends 36, 38 of the lap belt 34 in response to the signal 66. Each of the controller 62 and sensor 64 may be devices that are otherwise employed by the vehicle 12 for regulating the vehicle's active safety equipment, such as anti-lock braking and stability control systems.

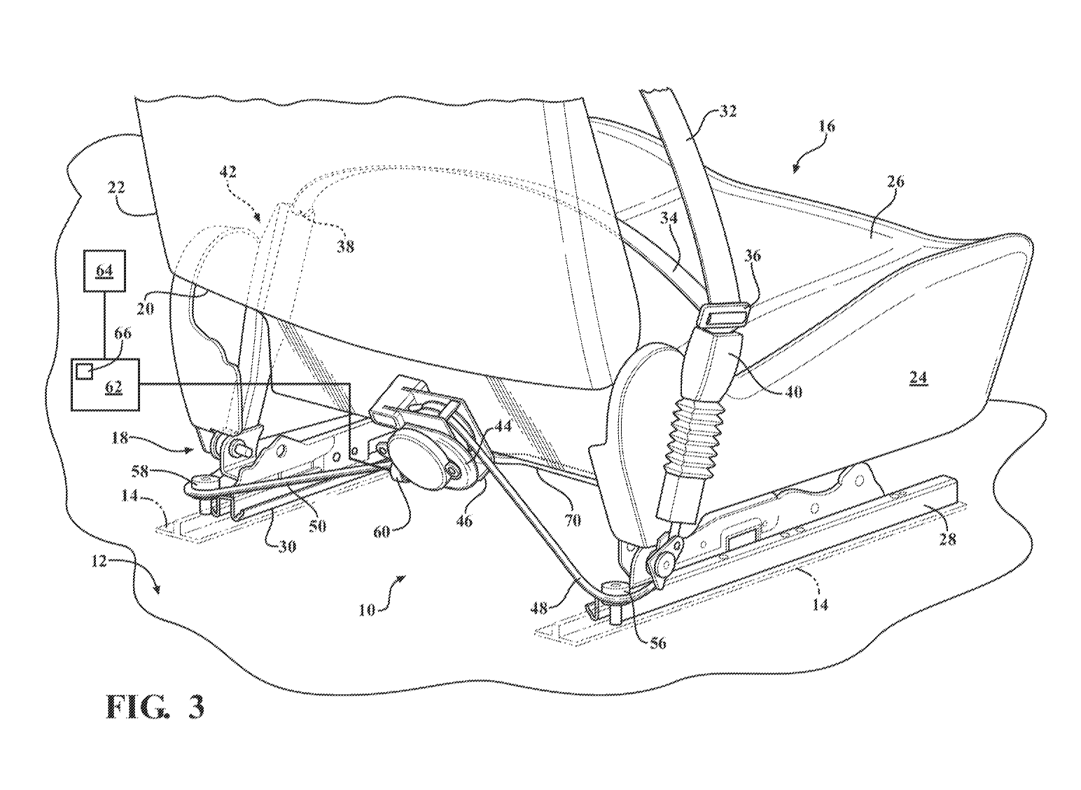

As shown in FIG. 1, the single retractor-pretensioner 44 may be operatively connected to the second seat structure 24 by a cross-member bracket 68 such that the single retractor-pretensioner is positioned under the cushion 26. The single retractor-pretensioner 44 may also be operatively connected to the first seat structure 20 by a cross-member bracket 70 and be positioned against the seatback 22, as shown in FIG. 3. In the event the single retractor-pretensioner 44 is connected to the first seat structure 20, the retractor-pretensioner the first and second cables 48, 50 may be covered by a trim panel (not shown), such that the apparatus is not exposed to the occupants of the vehicle 12.

While the best modes for carrying out the invention have been described in detail, those familiar with the art to which this invention relates will recognize various alternative designs and embodiments for practicing the invention within the scope of the appended claims.

1. A seat belt system for a vehicle, the seat belt system comprising:
a seat frame;
a lap belt having a first end and a second end, wherein the first end is connected to a buckle and the second end is connected to an anchor; and
a single retractor-pretensioner operatively connected to the seat frame and configured to simultaneously tension the first end and the second end.

2. The seat belt system of claim 1, wherein the single retractor-pretensioner includes a spool operatively connected to the first end of the belt via a first cable and to the second end of the belt via a second cable.

3. The seat belt system of claim 2, wherein the spool includes a first channel and a second channel, and wherein the first channel is configured to accept and guide the first cable and the second channel is configured to accept and guide the second cable.

4. The seat belt system of claim 2, wherein the seat frame includes a first structure configured to support a seatback and a second structure configured to support a cushion, and wherein the single retractor-pretensioner is operatively connected to the second structure and positioned under the cushion.

5. The seat belt system of claim 4, wherein the single retractor-pretensioner is operatively connected to the first structure and positioned against the seatback.

6. The seat belt system of claim 4, wherein the single retractor-pretensioner is configured to rotate the spool and simultaneously tension the first and second ends of the belt.

7. The seat belt system of claim 1, further comprising a sensor positioned on the vehicle and configured to generate a signal in response to a force having a predetermined magnitude, wherein the single retractor-pretensioner is triggered by the signal.

8. The seat belt system of claim 7, wherein the single retractor-pretensioner includes a pretensioning tube operatively connected to the spool and housing a pyrotechnic that is triggered to simultaneously tension the first and second ends of the belt in response to the signal.

9. The seat belt system of claim 8, further comprising a controller that is configured to trigger the pyrotechnic in response to the signal.

10. A vehicle comprising:
a vehicle structure; and
seat belt system having:
a seat having a seat frame operatively connected to the vehicle structure;
a lap belt having a first end and a second end, wherein the first end is connected to a buckle and the second end is connected to an anchor; and
a single retractor-pretensioner operatively connected to the seat frame and configured to simultaneously tension the first end and the second end.

11. The vehicle of claim 10, wherein the retractor-pretensioner includes a spool operatively connected to the first end of the belt via a first cable and to the second end of the belt via a second cable.

12. The vehicle of claim 11, wherein the spool includes a first channel and a second channel, and wherein the first channel is configured to accept and guide the first cable and the second channel is configured to accept and guide the second cable.

13. The vehicle of claim 11, wherein the seat frame includes a first structure configured to support a seatback and a second structure configured to support a cushion, and wherein the single retractor-pretensioner is operatively connected to the second structure and positioned under the cushion.

14. The vehicle of claim 13, wherein the single retractor-pretensioner is operatively connected to the first structure and positioned against the seatback.

15. The vehicle of claim 13, wherein the single retractor-pretensioner is configured to rotate the spool and simultaneously tension the first and second ends of the belt.

16. The vehicle of claim 10, further comprising a sensor operatively connected to the vehicle structure and configured to generate a signal in response to a force having a predetermined magnitude, and wherein the single retractor-pretensioner is triggered by the signal.

17. The vehicle of claim 16, wherein the single retractor-pretensioner includes a pretensioning tube operatively connected to the spool and housing a pyrotechnic that is triggered to simultaneously tension the first and second ends of the belt in response to the signal.

18. The vehicle of claim 17, further comprising a controller that is configured to trigger the pyrotechnic in response to the signal.
